(19) United States
(12) Patent Application Publication
(10) Pub. No.: US 2019/0174778 A1
(43) Pub. Date: Jun. 13, 2019

(54) MEAT TENDERIZATION AND SHELF LIFE EXTENSION

(71) Applicant: Sun Beef, LLC, Woodland, CA (US)

(72) Inventor: Robert Van Dorn, Danville, CA (US)

(21) Appl. No.: 16/216,385

(22) Filed: Dec. 11, 2018

Related U.S. Application Data
(60) Provisional application No. 62/597,715, filed on Dec. 12, 2017.

(51) Int. Cl. A22C 9/00; A22C 17/00; A23B 4/005

(52) U.S. Cl. CPC A22C 9/001; A22C 9/005; A22C 9/008; A23L 13/74; A22C 17/0093; A23B 4/005; A22C 17/0033

(57) ABSTRACT

The present disclosure describes methods and systems for processing meat products via mechanical tenderization and high-pressure pasteurization in a manner that improves the texture and extends the shelf life of the processed meat. Methods of meat processing may involve mechanically tenderizing the cuts of meat and slicing the cuts of meat into meat products. Methods may also involve packaging the meat products and pasteurizing the meat products under a high pressure. The meat products produced may have an extended shelf life compared to other meat products not mechanically tenderized and pasteurized under high pressure. The high pressure pasteurization, in addition to inactivating microorganisms, may further tenderize the meat products. Methods may also involve marinating the cuts of meat, which can be performed by injecting liquid marinate into the meat via mechanically operated injection needs in some examples. The liquid marinate may include natural enzymes that further tenderize the meat.

### TECHNICAL FIELD

Implementations relate to methods of processing meat products. More particularly, implementations involve processing raw meat products via mechanical tenderization and high-pressure pasteurization in a manner that improves the texture and extends the shelf life of the processed meat.

### BACKGROUND

The popularity of meat products derived from free-grazing, grass-fed cattle has increased dramatically in recent years. This popularity has been restrained, however, by several undesirable characteristics of the meat products produced from such cattle. For example, the beef tends to be tougher compared to meat products produced from cattle fed commercial feed products in large feed lots. In addition, beef derived from grass-fed cattle may contain fewer preservatives compared to other beef products, resulting in shorter shelf life. Without adjusting the lifestyle or feeding regimen of grass-fed cattle, improvements in the texture and shelf life of grass-fed beef products must be achieved through meat processing techniques; however, traditional processing options are hampered by ineffectiveness and safety concerns. For example, mechanical tenderization has been widely discontinued due to numerous reports of bacterial contamination caused by contaminated tenderization blades forcing bacteria deep into meat products during processing. Producing grass-fed meat products without compromising the living conditions of the cattle thus requires new methods of processing the meat in a manner that increases tenderness and shelf life without causing contamination.

### SUMMARY

In accordance with some examples provided herein, a method of processing cuts of meat may involve mechanically tenderizing the cuts of meat, slicing the cuts of meat into meat products, packaging the meat products, and pasteurizing the meat products under a high pressure. The meat products may have an extended shelf life compared to other meat products not mechanically tenderized and pasteurized under a high pressure, and pasteurizing the meat products under the high pressure may further tenderize the meat products.

In some examples, the method may further involve marinating the cuts of meat. In some embodiments, marinating the cuts of meat may involve injecting a liquid marinate into the cuts of meat using a plurality of mechanically operated injection needles, the liquid marinate comprising one or more components having an enzymatic activity configured to further tenderize the cuts of meat. According to some examples, after injecting the liquid marinate into the cuts of meat, a liquid marinate content of the cuts of meat may range from about 5 wt % to about 25 wt %.

In some embodiments, the method may further involve tumbling the meat products under a vacuum pressure. The vacuum pressure may range from about 5 psi to about 25 psi in some examples. In some implementations, the step of tumbling further may involve applying a flavor additive to the meat products. In some implementations, the flavor additive may include salt, paprika, ground celery seed, rosemary, pineapple juice powder, bromelain, and/or combinations thereof.

In some embodiments, mechanically tenderizing the cuts of meat may involve incising the cuts of meat with a plurality of blades. In some examples, packaging the meat products may involve vacuum sealing the meat products. In some embodiments, pasteurizing the meat products under a high pressure may involve pasteurizing the meat products for about 2 minutes to about 5 minutes at a pressure ranging from about 35,000 psi to about 85,000 psi. In some implementations, the cuts of meat may include primal cuts of uncooked beef derived from grass-fed cattle. In some embodiments, the extended shelf life of the meat products may comprise a shelf life increase of about 20% to about 50%. In some examples, the cuts of meat and meat products may not fall below 35° F. or exceed 41° F.

In accordance with some examples provided herein, a meat processing system may include a tenderizer apparatus configured to mechanically tenderize cuts of meat; a needle injection apparatus configured to marinate the cuts of meat; a slicing apparatus configured to slice the cuts of meat into meat products; a vacuum tumbler apparatus configured to apply a flavor additive to the meat products; a vacuum sealer apparatus configured to package the meat products; and a high pressure pasteurization apparatus configured to pasteurize the meat products under a high pressure, where the meat products have an extended shelf life compared to other meat products not mechanically tenderized and pasteurized under a high pressure.

In some examples, the tenderizer apparatus may include a plurality of blades configured to form a plurality of incisions within the cuts of meat. In some embodiments, the needle injection apparatus may include a plurality of needles configured to inject a liquid marinate into the cuts of meat by penetrating therein, thereby further tenderizing the cuts of meat. In some implementations, the high pressure pasteurization apparatus may be located at a separate location with respect to the tenderizer apparatus, the needle injection apparatus, the slicing apparatus, the vacuum tumbler apparatus, and the vacuum sealer apparatus. In some examples, the extended shelf life of the meat products may include a shelf life increase of about 20% to about 50%. In some embodiments, the flavor additive may include one or more components having an enzymatic activity configured to further tenderize the cuts of meat.

### BRIEF DESCRIPTION OF THE DRAWING

FIG. 1 is a flowchart of a method of processing cuts of meat, according to the present disclosure.

FIG. 2 is a graph showing cooked steak yield values for grass-fed steaks subjected to various tenderization treatments.

FIG. 3 is a graph showing tenderness values for the grass-fed steaks subjected to the tenderization treatments represented in FIG. 2.

### DETAILED DESCRIPTION

Implementations provide meat processing methods that improve the texture, flavor and/or shelf life of various meat products. Methods may involve a combination of enzymatic tenderization, mechanical tenderization and high pressure pasteurization (HPP), which extends shelf life and tenderizes otherwise tough meat without causing contamination. In some examples, HPP may further tenderize the meat while simultaneously inactivating unwanted microorganisms, such that the meat is subjected to tenderization via mechanical, enzymatic, and/or HPP approaches. Embodiments may further involve marinating meat products via needle injection, and enhancing the taste of meat products via topical application of various flavor additives. In some examples, the natural color of the meat products may also be maintained or prolonged. Meat products produced according to disclosed embodiments may also exhibit at least comparable yield (by weight) after cooking as steaks not processed according to such embodiments. The systems and methods described herein may be implemented for processing raw meat products derived from grass-fed, free-grazing cattle in some examples.

The types of meat, or base starting protein, processed according to the technology described herein can include primal cuts of meat, which include relatively large sections of meat that are often subdivided into individual meat products, such as steaks, before entering the marketplace. Primal cuts may include flank, brisket, short plate, shank, chuck, rib, round, and/or loin cuts. The primal cuts can be derived from grass-fed cattle, which may be allowed to graze freely in confined pastures. In some examples, the cattle may not be grass fed and/or not allowed to freely graze. In some examples, the primal cuts may be derived from other animals entirely, e.g., poultry, bison, goat, sheep. The primal cuts can be uncooked throughout processing. The meat may also be organic and substantially or completely untreated chemically at the onset of processing. In some embodiments, the meat can be slightly cooked and/or treated. While primal cuts are referred to herein, it is understood that other cuts of meat may also be amenable to the processing methods currently disclosed.

Processing may begin at a meat processing facility, e.g., a USDA-certified meat processing facility, where the primal cuts are received. Conditions at the processing facility can vary, but may be generally maintained in a manner that complies with food safety regulations. For example, production floor temperatures within the processing facility may be maintained at about 36° F. to about 39° F. In specific embodiments, the primal cuts can be delivered in corrugated shipping cases stored on a refrigerated delivery truck. Each case may contain about 4 to about 6 primal cuts, each case ranging from about 22 lbs. to about 45 lbs. Accordingly, the primal cuts may each weigh, for example, about 3.5 lbs. to about 11.5 lbs. The primal cuts are preferably stored in vacuum-sealed packages at a temperature ranging from about 35° F. to about 39° F. upon delivery. As described below, the meat temperature may be monitored throughout processing, e.g., at least once at each processing step and/or during transfer between processing steps, to ensure that the temperature remains within an acceptable range, e.g., above freezing but below about 39° F.

To prepare the primal cuts for processing, the cuts can first be placed in bins made of stainless steel or plastic, where the cuts can be weighed. The bins can then be transferred to a butcher trimming area, where the primal cuts are removed from their packaging and any blood loss from cuts measured. Each individual primal cut can then be trimmed manually or mechanically according to particular specifications, removing any excess fat in the process. After trimming, the trimmed primal cuts can be placed in a second, clean bin and weighed again to determine blood and trim loss. The prepared cuts of meat may then be processed in accordance with embodiments.

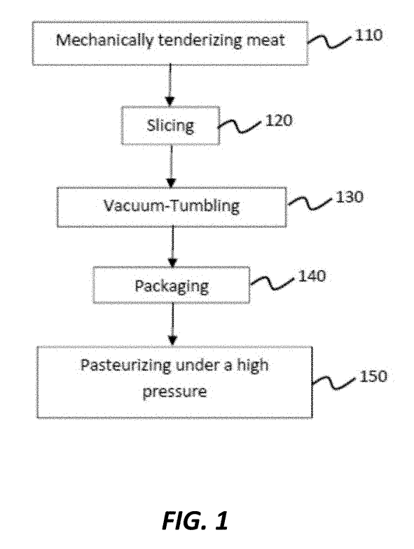

FIG. 1 is a flowchart of an exemplary method 100 of processing cuts of meat, according to the present disclosure. Referring to FIG. 1, the method involves mechanically tenderizing the cuts of meat in step 110. The meat may be sliced into meat products in step 120. The meat may be vacuum-tumbled in step 130. These meat products may be packaged in step 140. The meat products may be pasteurized under a high pressure in step 150. The steps of method 100 may be modified, replaced or arranged in any order, according to implementations of the present disclosure. These steps are more fully described herein.

### Mechanical Tenderization

The trimmed primal cuts can be subjected to mechanical tenderization to soften the meat. Tenderization may be especially important for processing primal cuts derived from grass-fed animals, such as cattle. In particular, the beef derived from grass-fed cattle may be tougher due at least in part to the increased physical activity levels of such cattle compared to cattle raised on feedlots. Mechanical tenderization may be implemented in a variety of ways. For instance, blade tenderization and needle injection are approaches to mechanically tenderizing meat.

Blade tenderization is a form of dry tenderization. Various tenderizer apparatuses can be used to perform blade tenderization, including a Ross Tenderizer by Ross Industries, Inc. During blade tenderization, a plurality of mechanically operated blades puncture the fibers and connective tissue comprising the meat as it passes through the tenderizer apparatus, thereby reducing the toughness of the meat by creating incisions therein. The number and depth of incisions created in each primal cut may vary, depending on the configuration of the tenderizer and/or the rate of meat passage therethrough. In some examples, the blades may penetrate to a depth of about 90% to about 95% of the thickness of the meat. In embodiments, the blade penetration depth may range from about 60% to about 95%, about 70% to about 90%, about 80% to about 90%, about 85% to about 95%, about 88% to about 92%, or about 90% of the thickness of the meat. In some embodiments, each primal cut may be passed through the tenderizer twice to allow blade penetration, and thus tenderization, of both sides of the meat. Mechanical tenderization may take about 15 seconds to about 20 seconds per passage through the tenderizer apparatus. In some examples, each passage may take less than 15 seconds, e.g., between 5 and 15 seconds, while in still other examples, each passage may take more than 20 seconds, for example 20 seconds to 1 minute. The temperature of the meat during tenderization may be maintained at about 32° F. to about 42° F., about 34° F. to about 40° F., about 35° F. to about 40° F., about 35° F. to about 38° F., or about 38° F. to about 40° F.

Needle injection is a form of wet tenderization. This form of tenderization may be referred to as marinating because during this tenderization process, needles inject a marinate into the primal cuts. In some approaches, the primal cuts can be needle tenderized (or marinated), for instance, after blade tenderization. The needle injection process involves inserting a plurality of needles containing the marinate into the meat, and injecting the marinate through the needles. The marinate components may improve the taste of the meat products, and may also improve the tenderness via one or more enzymatic components included in the marinate. In this manner, the marinating process may further tenderize the meat via injection needle penetration and, in some instances, by the enzymatic properties of the marinate itself.

The marinate composition may vary, and may be liquid or dry. In some embodiments, the marinate may include salt, ground celery seed, and/or a beef base. Particular examples may include SALTWELL salt, which may be preferred due to its approximately 30% reduction in sodium content compared to other forms of salt. The ground celery seed may prevent or at least reduce clostridium botulinum growth while increasing the natural nitrate content of the meat, which may cure the meat naturally. One or more natural enzymes may also be added to enhance tenderization of the meat. Ground celery seed, for example, also includes natural enzymes that further tenderize the meat. The beef base, which may be organic, can be added to enhance the taste of the meat. Embodiments may include additional marinate components, such as one or more oils and/or spices. In some examples, the marinate can be prepared in a blending tank containing a predetermined ratio of dry marinate to water, which may be chilled to a temperature ranging from about 20° F. to about 36° F., about 25° F. to about 33° F., about 28° F. to about 32° F., or about 30° F. in some examples. The dry marinate and chilled water can be blended until a homogenous liquid marinate is formed.

The liquid marinate can be pumped into an injector apparatus, e.g., an injector apparatus sold by Wolf-tech, Inc., which may include a plurality of needles configured to inject the liquid marinate under pressure directly into the tenderized meat. The injector apparatus may include a conveyor belt that moves the tenderized meat therethrough. As the meat passes through the injector apparatus, the needles containing the liquid marinate can be repeatedly moved into and out of the meat, injecting the marinate into the meat with each penetration. The injection pressure of the marinate entering the meat ejects the needles back out of the meat, such that marinate may be injected as the needles are being ejected, thereby distributing the marinate throughout the thickness of the meat. In some examples, the needles can be pushed about 90% of the way through each primal cut. In embodiments, the penetration distance relative to the thickness of the meat may vary, ranging from about 20%, 30%, 40%, 50%, 60%, 70%, 80%, 90%, 95%, or any range therebetween.

The number of times each cut of tenderized meat is injected with marinate may vary, and may depend on the speed setting of the conveyor belt and/or the frequency setting driving movement of the needles. In some examples, the meat is only injected from one side, requiring one passage through the injector apparatus. Each passage through the injector apparatus may take about 15 seconds to about 20 seconds. In some examples, each passage may take less than 15 seconds, e.g., between 5 and 15 seconds, while in still other examples, each passage may take more than 20 seconds, for example 20 seconds to 1 minute. The orientation of the meat during injection can vary. For example, the meat can be vertically or horizontally oriented as it passes through the injector apparatus. The needles used to inject the meat with liquid marinate may further tenderize the meat by creating additional incisions.

The target injection rate, i.e., the amount of marinate injected into each cut of meat, may vary based at least in part on the type of meat being processed. In some examples, the target injection rate may range from about 5 wt % to about 25 wt %, about 3 wt % to about 20 wt %, about 4 wt % to about 15 wt %, about 5 wt % to about 10 wt %, about 6 wt % to about 8 wt %, or about 7.34 wt %. The injector apparatus can be calibrated to achieve the target injection rate by weighing at least one of the tenderized meat cuts prior to marinating, and determining the amount of marinate required to satisfy the target injection rate. For example, if the target injection rate is 7.34 wt %, and the tenderized primal cut used to calibrate the injector apparatus weighs 8 lbs., then the target injection amount would be 0.59 lbs. and the total target weight of the meat would be 8.59 lbs. Using this calibration data, the injector apparatus can be programmed to inject about 0.59 lbs. of marinate into each cut of meat that passes therethrough. Temperature can be measured before and after the marinating process to ensure the temperature is maintained from about 35° F. to about 39° F. After marinating is complete, the marinated primal cuts can be quickly transferred to a slicing apparatus.

### Cutting

Mechanically tenderized primal cuts can be received at a cutting or slicing apparatus, e.g., a portioning apparatus sold by MARELEC Food Technologies. Quickly transferring the marinated cuts to the slicing apparatus is preferred in order to maintain as much marinate in the meat as possible, thereby preventing or at least minimizing the amount of marinate that may naturally purge from the meat over time.

Multiple cuts of meat, which may be referred to as steaks, can be prepared from each individual primal cut. Depending on the size of each primal cut and the desired size of the steak, the slicing apparatus can be calibrated to prepare individual steaks in a range of sizes. In some examples, the slicing apparatus can be calibrated to prepare 12 oz. cuts of meat. Weight tolerances may vary. For example, the accepted variation in steak weight may be about +/−2 oz., such that any steaks with a target weight of 12 oz. that weigh between about 10 oz. and about 14 oz. are approved for additional processing. Steaks weighing more than 14 oz. may be subjected to additional slicing to arrive within the accepted weight range. Depending on the steak size desired and/or the accepted tolerance level, steak size may range from about 4 oz. to about 32 oz., about 6 oz. to about 24 oz., about 8 oz. to about 16 oz., or about 10 oz. to about 14 oz. in different embodiments. The thickness of each steak may vary, ranging from about 0.25 inches to about 1.75 inches, about 0.5 inches to about 1.5 inches, about 0.75 inches to about 1.25 inches, or about 1 inch.

After slicing the primal cuts into individual steaks, the steaks can be returned to a bin, where the temperature may be measured again. As before, the temperature should be maintained in a range from about 35° F. to about 39° F. The weight of the steaks in the bins can also be measured. In some examples, the bins may be filled with about 600 lbs. of steaks, but the total weight in each bin may vary. The measured weight is used to calculate the amount of topical flavor additives that will be applied in the next processing phase.

### Vacuum-Tumbling

To evenly distribute the flavor additives on the steaks, the steaks may be combined with flavor additives in a vacuum tumbler apparatus, e.g., a vacuum tumbler sold by FPEC Corp. The tumbler chamber of the apparatus may be pressurized to about 5 psi to about 50 psi, about 5 psi to about 25 psi, about 10 psi to about 50 psi, about 15 psi to about 40 psi, about 20 psi to about 30 psi, or about 25 psi. During vacuum-tumbling, increased pressure within the chamber may cause the meat to expand in size and the pores of the meat to open. To apply the flavor additives, which may comprise a wet or dry rub, the tumbler apparatus may rotate analogously to the rotation of a cement mixer. The various flavor additives may pool in the bottom of the tumbler chamber. During tumbling, the meat repeatedly drops to the bottom of the tumbler chamber. Repeated falling, in conjunction with pressurization of the chamber, may open the pores of the meat, further tenderizing the meat and providing a route for the flavor additives to be absorbed. When the vacuum is released, the meat may shrink back down to its original size, trapping the absorbed flavor additives therein.

A plurality of steaks, e.g., all 600 lbs. worth of steak included in a single bin, can be placed within the vacuum tumbler apparatus simultaneously. The amount of flavor additives added to the vacuum tumbler may vary depending on the target flavor content. For example, about 9 lbs. of flavor additives can be combined with about 600 lbs. of steak to satisfy a targeted flavor additive content of 1.5 wt %. Once the steaks and flavor additives are added to the vacuum tumbler apparatus, the mixture may be gently mixed under vacuum pressure for about 1 minute to about 25 minutes, about 1 minute to about 20 minutes, about 1 minute to about 15 minutes, about 3 minutes to about 10 minutes, about 1 minute to about 5 minutes, or about 3 minutes to about 4 minutes. The temperature within the vacuum tumbler may be monitored continuously so that it does not fall below about 35° F. or about 32° F., and does not rise above about 38° F. to about 39° F. during tumbling. After tumbling, the steaks are removed from the tumbler apparatus. Steak removal can be accomplished by reversing the tumbling direction of the vacuum tumbler while opening an end of the apparatus.

Various forms of flavor may be added to the steaks during vacuum-tumbling. Initially, one or more flavor additives, e.g., spices and/or seasonings, can be applied topically to the meat or may be applied to the vacuum tumbler. The flavor additives may improve the taste of the steaks, further tenderize the steaks, and/or further extend their shelf life. Flavor additives can be added in liquid or dry form, e.g., a rub, and may include proprietary mixtures of flavors. The amount of flavor additives added to each steak can vary depending on the specific type of meat product being prepared. In some examples, the flavor additive content may range from about 0.1 wt % to about 5 wt %, about 0.5 wt % to about 4 wt %, about 1 wt % to about 3 wt %, about 1 wt % to about 2 wt %, about 1 wt % to about 1.8 wt %, or about 1.5 wt % of each steak. The flavor additive content may equal the total content of all individual spices, seasonings, or flavor blends included in each steak.

In some embodiments, the flavor additives may include salt, e.g., Kosher salt and/or SALTWELL salt. The salt contributes to the taste of the steaks, extracts moisture from within the steaks, and may also enhance the microbial stability of the steaks. Ground celery seed may also be included as a flavor additive in some examples. As stated above, ground celery seed may prevent or at least reduce clostridium botulinum growth while providing a natural nitrate curing component. Ground celery seed also includes natural enzymes that further tenderize the steaks. Bromelain and/or pineapple juice powder may also be included. These additives provide natural sources of bromelain protease, which can further tenderize the meat by breaking down protein molecules present therein. In some examples, papaya juice and/or papaya juice powder may also be included, which provide natural sources of papain, which can also tenderize the meat. In some examples, smoked paprika may be included. In addition to bestowing the meat with a smoky flavor, the smoked paprika can further tenderize the meat and contribute to the natural color of the meat, such that it appears in a fresh state, thereby prolonging the visual acceptability of the meat in the marketplace. Rosemary can also be included, which also contains tenderizing enzymes. Any of the aforementioned example flavor additives can be excluded from the steaks, and any two or more of the additives may be combined, while additional flavor additives can be included as desired for various meat products. The proportion of the enzymes included in the meat products may be varied to adjust the rate and/or extent of meat tenderization.

### Packaging

The tenderized, cut, and/or vacuum-tumbled steaks can next be packaged. Packaging may involve vacuum sealing the steaks individually or in groups of two or more steaks. A vacuum sealer apparatus may be used at this step, e.g., a CRYOVAC or MULTIVAC apparatus with adjustable die sizing. The vacuum sealer apparatus can seal the steaks within films of variable thickness. For example, the film may be about 1 mm., 2 mm., 3 mm., 4 mm., 5 mm., 6 mm., 7 mm., 8 mm., 9 mm., or about 10 mm. thick. The film can be transparent or opaque. In embodiments, a combination of two films may be used for each package. For example, a transparent, 9 mm. forming film may be used in conjunction with an opaque, 3 mm. non-forming film. The opaque film may cover the bottom portion of the steak, while the transparent film may be applied to the remainder of each steak. To apply the films, individual steaks can be placed into the die of the vacuum sealer apparatus, where the transparent forming film has been formed by the apparatus and the black non-forming film has been applied to the bottom portion of each package. A vacuum is pulled after placing the steak onto the opaque film, and the two films are heat-sealed together. The packaged steaks can then be placed into bulk shipping cases for transfer.

### High Pressure Pasteurization

High pressure pasteurization (HPP) may be implemented to inactivate unwanted microorganisms present on or within the packaged meat products, thereby extending the shelf life of the products. In this manner, HPP allows mechanical tenderization to be performed by offsetting the associated risk of bacterial contamination. Moreover, HPP may be performed without causing discoloration of the meat products, and may further tenderize the meat products via application of high pressure. In some implementations, HPP may be employed to tenderize the meat products instead of needle tenderization. HPP may also be employed to increase tenderization such that needle tenderization and/or other methods of tenderization that involve mechanical tenderizing components may be minimized.

HPP may involve pressurizing the vessel chamber containing the packaged steaks for a specified period of time. The maximum pressure, as well as the manner in which pressure levels are increased or decreased, may vary. In some examples, a target pressure must be maintained for a target period of time sufficient to extend the shelf life of the packaged meat products. For instance, in some embodiments a target pressure of about 85,000 psi must be maintained for about 180 seconds to completely pasteurize the meat. In additional examples, the minimum target pressure necessary for pasteurization may be lower, e.g., about 25,000 psi to about 70,000 psi, about 29,000 psi to about 58,000 psi, about 35,000 psi to about 85,000 psi, or about 58,000 psi to about 85,000 psi. Additional target pressures may range from about 50,000 psi to about 80,000 psi, about 55,000 psi to about 65,000 psi, about 58,000 psi, about 60,000 psi to about 70,000 psi, or about 70,000 psi to about 80,000 psi. Higher maximum pressures, e.g., about 85,000 psi to about 110,000 psi, about 85,000 psi to about 90,000 psi, or about 87,000 psi may also be implemented, but in some cases, pressures above about 85,000 psi may cause discoloration of the meat. According to such examples, one or more spices or colorizers, e.g., paprika, may be added prior to HPP to compensate for this discoloration. In some examples, the pasteurization pressure may be varied to influence the characteristics of the meat. For example, lower pressure levels, e.g., about 29,000 psi to about 58,000 psi, may be implemented to increase the tenderization of the meat, while higher pressure levels, e.g., about 58,000 psi to about 87,000 psi, may be implemented to increase the shelf life of the meat. Tenderization of the meat achieved via HPP may improve the efficiency of the systems described herein by inactivating unwanted microorganisms and improving tenderization simultaneously. In some examples, overall processing time may be reduced by increasing the tenderization accomplished via HPP, such that less processing time is dedicated to mechanical tenderization, for instance. The length of time the meat must be maintained at the target pressure may also vary. For example, the required time spent at the target pressure may range from about 30 seconds to about 300 seconds, about 60 seconds to about 240 seconds, about 120 seconds to about 200 seconds, about 140 seconds to about 180 seconds, about 180 seconds, or about 160 seconds. In some examples, the pressure may be increased and/or decreased in stepwise fashion, such that various pressures are held constant for various periods of time. In other examples, the pressure is increased and/or decreased in linear fashion. By subjecting the packaged meat products to high pressure, microorganisms present on or within the products are killed, the products are tenderized, and the shelf life of the products is extended.

The capacity of the vessels, and thus the number of steaks simultaneously loaded therein, may vary. In at least one example, the capacity of the vessels may be about 200 lbs., but the capacity may range from about 50 lbs. to about 500 lbs., about 100 lbs. to about 400 lbs., or about 150 lbs. to about 300 lbs. The temperature within the vessel chamber may be measured before and after HPP. In some examples, the loading temperature (before HPP) may be different than the exit temperature (after HPP). For instance, the loading temperature may range from about 38.2° F. to about 39.1° F., while the exit temperature may range from about 40° F. to about 40.4° F. In some examples, the loading temperature may range from about 35° F. to about 40° F., about 36° F. to about 39° F., or about 38° F. to about 40° F. The exit temperature may range from about 39° F. to about 42° F., about 40° F. to about 42° F., or about 40° F. to about 41° F.

In some implementations, the packaged meat may be allowed to rest for a period of time prior to HPP. The resting period may be implemented to allow the natural enzymes and/or other components to tenderize the meat prior to inactivation of the enzymes during HPP. Accordingly, the resting period may be considered an enzymatic working period and may be specified by a user to control the activity of the enzymes, and thus the tenderization of the meat products. Depending on the enzymes used, the size of the meat products and/or desired tenderization levels, the resting period may vary. In some examples, the meat may be subjected to HPP about 8 to 48 hours after packaging, while in other examples, the resting period may range from about 1 to about 72 hours, about 2 to about 64 hours, about 4 to about 56 hours, about 12 to about 40 hours, about 18 to about 36 hours, about 22 to about 26 hours, or about 24 hours. During the resting period, the activity of the enzymes may be naturally exhausted. Accordingly, the resting period may be similar to or longer than the length of time the enzymes remain active. The duration of the resting period may therefore be tailored to the enzymatic lifespan of the enzymes employed. In some examples, the duration of the resting period may be approximately equal to the length of time the enzyme having the longest activity lifespan remains active. Alternatively, for example if allowing the enzymes to remain active for the maximum natural period would over-tenderize the meat, the resting period may be shortened by initiating HPP and halting enzymatic activity. Stopping the enzymatically catalyzed tenderization may thus be achieved by initiating HPP in some examples. In addition or alternatively, enzymatically catalyzed tenderization may be halted by adjusting the temperature of the meat products. For instance, the temperature of the meat products may be adjusted to be either above or below the temperature range conducive to activity of one or more of the enzymes. In this manner, enzymatic activity may also be slowed or accelerated. Accordingly, methods of stopping or slowing enzymatic tenderization may be implemented when HPP is temporarily unavailable or delayed. In specific implementations, enzymatic tenderization may be stopped after about 24 hours via HPP or an alternative method of altering the meat processing conditions, e.g., increasing or decreasing the temperature of the meat products.

After HPP has been completed, the packaged meat products can be transferred to a refrigerator or freezer, where the temperature is reduced down to about 35° F. to about 39° F. for storage. The resulting extent of shelf life extension exhibited by the meat products may vary, shelf life being defined as the length of time after processing that the meat products may remain refrigerated before spoiling. Compared to identical or similar meat products not processed according to the methods described herein, the shelf life extension of the meat products may range from about 10% to about 100%, about 10% to about 80%, about 15% to about 60%, about 20% to about 50%, about 30% to about 40%, about 25% to about 35%, or about 30%.

HPP may be performed at a separate facility, i.e., away from the facility used to prepare and package the steaks. During transfer of the packaged steaks to the separate HPP facility, the steaks should be maintained at a temperature of about 35° F. to about 39° F. This may be accomplished by transporting the steaks in a refrigerated truck. The steaks may arrive at the facility in bulk cases weighing about 40 lbs. in some examples. At the separate facility, an HPP apparatus, e.g., an HPP apparatus sold by Avure Technologies, Inc., may be used to pasteurize the steaks via high pressure. The temperature of the HPP facility may be the same as the temperature at which the steaks are transported thereto, i.e., about 35° F. to about 39° F.

In some examples, the packaged meat products are prepared for HPP within 24 hours of arriving at the HPP facility. The steaks are unloaded from the cases used to transfer them and loaded into the HPP vessels.

The improved tenderness of the meat compared to identical or similar meat products not processed according to the methods herein may be evaluated via machine-based techniques, e.g., shear testing such as Warner-Bratzler Shear Force (WBSF) testing, or human palette testing. In some embodiments, the meat products may exhibit WBSF tenderness values measuring between 0 and about 3.2 KgF (lower values=more tender). For example, meats subjected to a combination of organic marinate injection, e.g., needle injection, plus topical bromelain treatment, e.g., via vacuum tumbling, and HPP may exhibit tenderness values less than about 3.2 KgF. Likewise, meats subjected to a combination of marinate injection and topical bromelain treatment, along with meats subjected to blade tenderization, only, may exhibit tenderness values less than 3.2 KgF. By contrast, meats not subjected to one or more of the tenderization steps described herein may exhibit higher WBSF tenderness values, for example at least between 3.5 KgF and about 4.0 KgF.

Meat products processed according to embodiments disclosed herein may also exhibit similar cooked steak yield (CSY) values to meat products not processed according to methods herein, meaning that even though the meat products produced according to methods herein may be more tender when raw, the products may maintain at least a comparable weight after cooking as tougher meats not processed according to the disclosed methods. In various examples, meat products produced according to disclosed embodiments may exhibit CSY values ranging from about 73% to about 78%.

### Additional Examples

The processing steps described herein may be performed in a variety of combinations, resulting in additional examples of meat processing approaches that improve the texture, flavor, color, and/or shelf life of various forms of meat, e.g., grass-fed meat. For example, one or more techniques for tenderizing, vacuum-tumbling and/or adding flavor to the meat products may be replaced with one or more alternative techniques, as described below.

Embodiments may involve various forms of mechanical tenderization, e.g., blade and/or needle tenderization. In some examples, blade tenderization may be omitted, and tenderization may be performed via needle injection, only. In some examples, needle tenderization may be performed without simultaneous marinate injection. Such examples may involve first tenderizing the meat using mechanically operated needles, followed by marinate addition in a vacuum tumbler apparatus. Needle tenderization may also be omitted in some examples. Such examples may involve blade tenderization followed by marinate addition via vacuum tumbling, which may further tenderize the meat. Embodiments involving blade and/or needle tenderization may be followed by HPP to further tenderize and decontaminate the meat products.

In some embodiments, mechanical tenderization may be replaced entirely or at least in part by enzymatic tenderization effected via the components of the flavor additives and/or marinate. Reliance on enzymatic tenderization may depend on the specific components of the marinate and/or flavor additives. For example, the greater the enzymatic activity of the marinate and/or flavor additive components, the more that mechanical tenderization can be reduced. In some embodiments, the enzymatic activity of the flavor additives and/or marinate may cause sufficient tenderization in combination with the tenderizing effected via vacuum tumbling and HPP, such that mechanical tenderization implemented via blades and/or needles may be omitted entirely. In other examples, one form of mechanical tenderization may be eliminated. For example, enzymatic tenderization may be implemented in combination with blade tenderization or needle tenderization. Likewise, additional mechanical tenderization may be implemented to compensate for low enzymatic activity of the flavor additives and/or marinate. For example, blade and/or needle tenderization may be prolonged and/or the depth of the incisions increased when the enzymatic activity of the marinate/flavor additives is low and/or when addition of the marinate/flavor additives is not performed via vacuum tumbler.

In some examples, the marinate may be applied in a step separate from needle tenderization. In addition or alternatively, flavor enhancers such as spices, may be applied in a separate step from vacuum-tumbling. Moreover, in some examples, the techniques used to apply flavor additives may be combined with the techniques used to marinate the meat. Flavor enhancement and marinating may both be performed simultaneously in a vacuum tumbler apparatus, for example. Such examples may involve blending the flavor additives with a liquid marinate to form a mixture, and then adding the mixture to the vacuum tumbler. Additional embodiments may involve adding both the marinate and the flavor additives via needle injection. Such examples may omit implementation of the vacuum tumbler, or may include the vacuum tumbler as a means for improving marinate/flavor additive absorption and/or increasing the tenderness of the meat.

### Trial

An experimental trial was conducted to evaluate the cooked steak yield and tenderness of grass-fed steaks subjected to various tenderization treatments, including those disclosed in embodiments herein.

Materials and Methods

Natural, grass-fed beef strip loins were shipped to a processing facility and cut into individual steaks each weighing about 12 ounces and measuring about 1 inch thick. Each of the steaks were then subjected to 1 of 5 different tenderization treatments: (1) organic marinate injection, topical bromelain treatment and HPP, (2) organic marinate injection and topical bromelain treatment, (3) organic marinate injection, only, (4) blade tenderization, only, and (5) no treatment (negative control). After treatment, the steaks were shipped, stored under refrigeration temperatures (about 4° C.), cooked to a temperature of about 160° F. (71.1° C.), and subsequently allowed to cool to room temperature (about 22° C.) for about 4 hours, at which point each steak was evaluated for tenderness. Raw steak weight and cooked steak weight were recorded for each steak to calculate cooked steak yield (CSY), which indicates the weight loss that occurs upon cooking the steaks. To assess tenderness, 4 to 8 core samples each measuring about 1 cm in diameter were removed from each steak, each sample removed parallel to the muscle fibers. The samples were then subjected to Warner-Bratzler Shear Force (WBSF) testing using a G-R Shear Machine Model Number GR-151 produced by the G-R Electric Manufacturing Company, LLC. The WBSF results (in KgF) were recorded and averaged for each steak. Lower WBSF values indicate greater tenderness.

Results

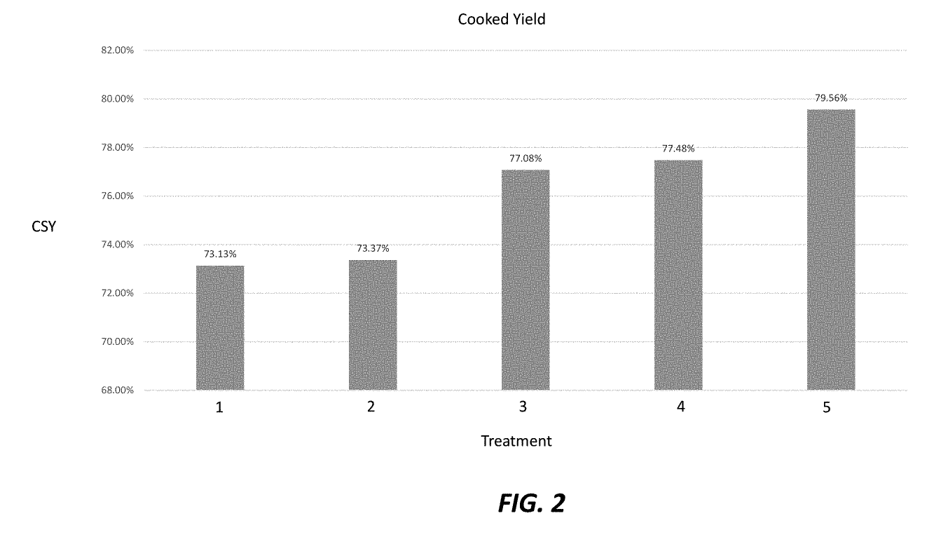

FIG. 2 shows the CSY values determined for the steaks subjected to each treatment.

Treatment 5 produced the highest CSY of about 79.56%, followed by treatments 4, 3, 2 and then 1, in that order. Accordingly, CSY decreased as the invasiveness of the applied treatments increased. Marinate injection may have impacted (decreased) the CSY values at least in part by increasing the volume of liquid available for evaporation during each treatment, thereby lowering CSY by creating a greater disparity in steak weight before and after treatment. Notably, none of the treatments produced statistically significant differences in CSY, indicating that while marinate injection may increase the amount of liquid available in the meat, the CSY of such meat after treatment may not appreciably decrease.

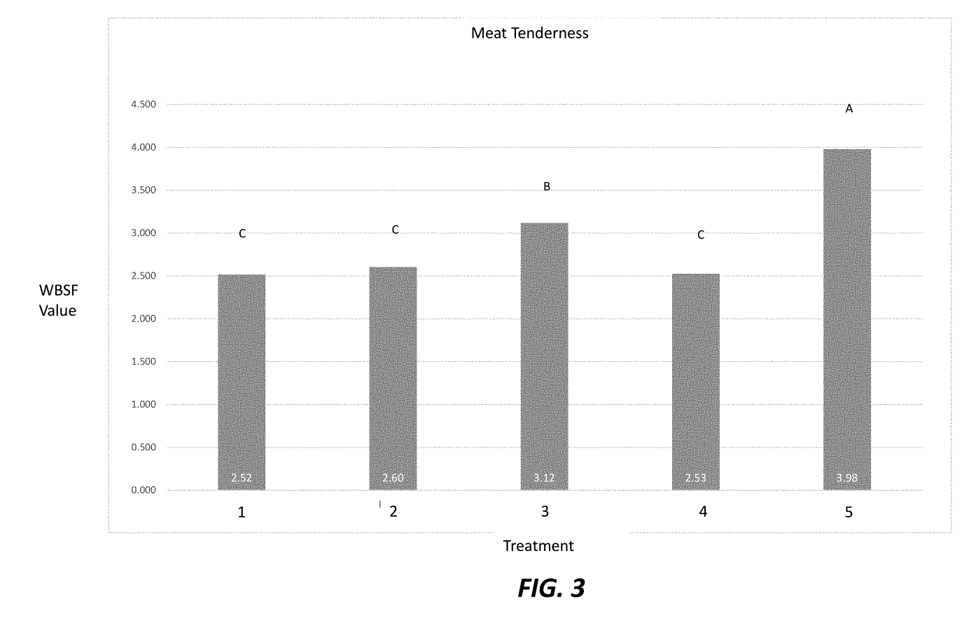

FIG. 3 shows the WBSF tenderness results for each treatment. As shown, treatments 1, 2 and 4 produced statistically similar WBSF values, which were less than the WBSF values produced for treatments 3 and 5. The steaks subjected to treatments 1 and 4 showed the least amount of variation within each treatment, producing standard deviations of 0.27 and 0.28, respectively, Notably, all steaks subjected to treatments 1 and 4 reached tenderness values less than 3.2 KgF, qualifying them for the USDA's “very tender” classification. Steaks subjected to treatment 2 showed greater variation in tenderness values (s.d. 0.7), and 83.33% of such steak samples reached tenderness values less than 3.2 KgF. The variation observed within treatment 2 could be attributed to variation in the treatment itself, or due to natural variation within the strip loins used for the experiment. The steaks exhibiting the highest toughness values (least tender) were subjected to treatment 5. Thus, the steaks not subjected to tenderization treatment remained the most tough, while the steaks subjected to a combination of organic marinate injection, topical bromelain treatment and HPP (treatment 1), organic marinate injection and topical bromelain (treatment 2) and blade tenderization, only (treatment 4) showed significantly greater tenderness. Steaks subjected to treatment 1 were the most tender of all treatments, exhibiting a WBSF value of only 2.52.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of processing cuts of meat, the method comprising:
mechanically tenderizing the cuts of meat;
slicing the cuts of meat into meat products;
packaging the meat products; and
pasteurizing the meat products under a high pressure, wherein the meat products have an extended shelf life compared to other meat products not mechanically tenderized and pasteurized under a high pressure, wherein pasteurizing the meat products under the high pressure further tenderizes the meat products.

2. The method of claim 1, further comprising marinating the cuts of meat.

3. The method of claim 2, wherein marinating the cuts of meat comprises injecting a liquid marinate into the cuts of meat using a plurality of mechanically operated injection needles, the liquid marinate comprising one or more components having an enzymatic activity configured to further tenderize the cuts of meat.

4. The method of claim 3, wherein after injecting the liquid marinate into the cuts of meat, a liquid marinate content of the cuts of meat ranges from about 5 wt % to about 25 wt %.

5. The method of claim 1, further comprising tumbling the meat products under a vacuum pressure.

6. The method of claim 5, wherein the vacuum pressure ranges from about 5 psi to about 25 psi.

7. The method of claim 5, wherein the step of tumbling further comprises applying a flavor additive to the meat products.

8. The method of claim 7, wherein the flavor additive comprises salt, paprika, ground celery seed, rosemary, pineapple juice powder, bromelain, and/or combinations thereof.

9. The method of claim 1, wherein mechanically tenderizing the cuts of meat comprises incising the cuts of meat with a plurality of blades.

10. The method of claim 1, wherein packaging the meat products comprises vacuum sealing the meat products.

11. The method of claim 1, wherein pasteurizing the meat products under a high pressure comprises pasteurizing the meat products for about 2 minutes to about 5 minutes at a pressure ranging from about 35,000 psi to about 85,000 psi.

12. The method of claim 1, wherein the cuts of meat comprise primal cuts of uncooked beef derived from grass-fed cattle.

13. The method of claim 1, wherein the extended shelf life of the meat products comprises a shelf life increase of about 20% to about 50%.

14. The method of claim 1, wherein the cuts of meat and meat products do not fall below 35° F. or exceed 41° F.

15. A meat processing system, the system comprising:
a tenderizer apparatus configured to mechanically tenderize cuts of meat;
a needle injection apparatus configured to marinate the cuts of meat;
a slicing apparatus configured to slice the cuts of meat into meat products;
a vacuum tumbler apparatus configured to apply a flavor additive to the meat products;
a vacuum sealer apparatus configured to package the meat products; and
a high pressure pasteurization apparatus configured to pasteurize the meat products under a high pressure, wherein the meat products have an extended shelf life compared to other meat products not mechanically tenderized and pasteurized under a high pressure.

16. The system of claim 15, wherein the tenderizer apparatus comprises a plurality of blades configured to form a plurality of incisions within the cuts of meat.

17. The system of claim 15, wherein the needle injection apparatus comprises a plurality of needles configured to inject a liquid marinate into the cuts of meat by penetrating therein, thereby further tenderizing the cuts of meat.

18. The system of claim 15, wherein the high pressure pasteurization apparatus is located at a separate location with respect to the tenderizer apparatus, the needle injection apparatus, the slicing apparatus, the vacuum tumbler apparatus, and the vacuum sealer apparatus.

19. The system of claim 15, wherein the extended shelf life of the meat products comprises a shelf life increase of about 20% to about 50%.

20. The system of claim 15, wherein the flavor additive comprises one or more components having an enzymatic activity configured to further tenderize the cuts of meat.
